(19) United States
(12) Patent Application Publication
(10) Pub. No.: US 2017/0026773 A1
(43) Pub. Date: Jan. 26, 2017

(54) CELL-PHONE BAZAAR

(71) Applicant: CELL BUDDY NETWORK LTD., Tel Aviv (IL)

(72) Inventors: Ofir PAZ, Rishon LeZion (IL); Erez DORON, Tel Aviv (IL); Simcha ARONSON, Ra'anana (IL)

(21) Appl. No.: 15/300,815

(22) PCT Filed: Apr. 2, 2015
(86) PCT No.: PCT/IB2015/052451

§ 371 Date: Sep. 30, 2016

Related U.S. Application Data
(60) Provisional application No. 61/974,519, filed on Apr. 3, 2014.

(51) Int. Cl. H04W 4/00; H04M 15/00; H04W 4/24

(52) U.S. Cl. CPC H04W 4/001; H04W 4/24; H04M 15/858; H04M 15/84; H04M 15/80; H04M 15/745

(57) ABSTRACT

A cell-phone comprising a set of executable instructions that configures the cell-phone to receive and display a menu showing a plurality of service plans for selection by the user, each service plan being characterized with one or more terms under which the user uses the services of a cell-phone phone network; determine a selection that a user makes; and transmit a message via a communication network making the selection of the service plan known.

### RELATED APPLICATION

The present application claims the benefit under 35 U.S.C. 119(e) of U.S. Provisional Application 61/974,519 filed on Apr. 3, 2014 the disclosure of which is incorporated herein by reference.

### TECHNICAL FIELD

Embodiments of the invention relate to methods of acquiring a service plan to use the services of a cell phone network with a cell phone.

### BACKGROUND

A modern cell-phone communication network established and maintained by a cell-phone network operator typically provides full duplex, wireless communication services between mobile communication devices in a geographically localized service area. The communication devices, referred to in the industry as mobile equipment (ME), appear in their most common format as the globally ubiquitous cell-phones and smart-phones, but may also appear as, or be comprised in, any of various other devices, such as a laptop, tablet, or personal digital assistant (PDA). For convenience of presentation, mobile equipment, in any of its forms, is generically referred to also as a cell-phone.

To use the services of a cell-phone network, a user enters into a contract with the operator of the network to purchase a cell-phone service plan, which may be referred to as a “service plan” or a “plan”, of services offered by the network. The service plan provides terms under which the user will use the services of the network, including but not limited to which services are available for use by the user, the time period for use, and billing rates for services such as voice, text messaging, and data. The plan may optionally be provided to a user directly by the operator of the cell-phone network or a by a third party vendor that arranges contracts for service plans with one or more cell-phone networks. An entity that provides service plans for purchase to users, whether a cell-phone network operator or a third party vendor, may be referred to generically as a “service provider”. The service plan permits the user to access the cell-phone network using a cell-phone and use the services provided by the purchased plan. In contracting to use the services of the network, the user generally has a choice of various plans that package different configurations of services and cost options. A service plan typically stipulates a number of minutes of voice communication, (“talk minutes”), an amount of data communication and associated data transfer rates, text, picture and/or video messaging services, and/or other features, which may include “freebies”—free services, which the operator packages with the plan to improve its customer appeal. Payment arrangement for the plan may optionally be a flat-rate plan having a fixed set of services in exchange for fixed regular payments. The plan may optionally be a pre-paid plan, a post-paid plan, or a pay-as-you-go plan having for example a fixed cost per unit time for phone calls and/or a fixed cost per message for messaging services. The plan also defines a geographical area for which the plan applies. The geographical area includes the service area of the network and typically service areas of other networks with which the network has service agreements.

Upon the user choosing a plan and entering into the contract through the interactive menu, the service provider provides the user with a smart card referred to as a subscriber identity module (SIM), or universal subscriber identity module (USIM), hereinafter generically referred to as a SIM or SIM card. The SIM card is usually removably seated in a recess or slot in the user's cell-phone. Some cell-phones have a non-removable SIM built into the cell-phone circuitry. Reference to a SIM or SIM card is a generic reference to removable and built in SIMs unless otherwise indicated explicitly or by context. The SIM has a memory stored with a unique international mobile subscriber identity (IMSI) code that identifies the SIM and, a typically 128 bit, authentication key “KI”. The KI is generally not accessible from the SIM but is used by the SIM to generate responses to identity authentication challenges presented to the cell-phone by the network. The cell-phone network that supports the service provider issuing the SIM card is referred to as a “home network” of the SIM card

To access services of the home cell-phone network when located in the home network service area, the cell-phone must identify itself to the home network by presenting its SIM card IMSI to the home network. Following recognition of the IMSI by the home network, the cell-phone and home network engage in an authentication procedure to authenticate the SIM card. In the procedure, the home network challenges the cell-phone by sending it data, typically a random number, which the cell-phone's SIM processes using its KI to generate a response. The cell-phone transmits the response to the home cell-phone network, and if the response is what the home network expects, it allows the cell-phone access to its services. Generally, once identified and authenticated by its home network, barring aberrant events such as unforeseen disruption of services or security challenges, a cell-phone may move around in its home network service area without further requirement of authentication.

If the cell-phone leaves its home network service area it is considered to have roamed from the home network's service area to a service area of another cell-phone network, in which it becomes a “visitor” to the other network. To access communication services the visiting cell-phone must request and acquire authorization to use the visited cell-phone network. To make the request, the visiting cell-phone identifies itself to the visited network by presenting its IMSI to the visited network. Assuming that the visited network has an agreement to provide services to cell-phones roaming to the visited network from the visiting cell-phone's home network, the visited network transmits the visitor's IMSI to the visitor's home network to initiate an authentication procedure between the visitor and the visitor's home network. The visited network functions as a transceiver for communications between the visitor and the home network during the authentication procedure. If authentication procedure is successful, the visited network allows the visitor to use its communication services.

Current cell-phones are configured to detect cell-phone networks within operating range of the cell-phone. Upon being turned on after being shut down or leaving its home network, the cell-phone generally detects which cell-phone networks are within range of the cell-phone and are technically able to provide the cell-phone with communication services. Generally, if the cell-phone is operating in its home network service area, the cell-phone will not display detected cell-phone networks other than the home network and automatically connects to the home network. When roaming outside of the home network the cell-phone generally displays a list of detected networks which may be accessed as visited networks. The user may manually select a network to access for services from the list or allow the cell-phone to automatically select a network from the list. Aside from emergency calls, which are usually allowed on any network, the cell-phone will be provided with access to the selected network if the selected network has an operating agreement within the cell-phone's home network.

### SUMMARY

An aspect of an embodiment of the invention relates to providing a cell-phone user with a cell-phone “bazaar” that creates an interactive “bazaar menu” of service plans made available by service providers from which menu the user may select a service plan for the user's cell phone. Plans in the bazaar menu are provided with details of terms of the plans that might be of use to the user in determining which plan in the bazaar menu suits his or her needs. The terms may for example identify service providers, geographical coverage of the plans, duration of the plans, and billing rates for voice, text messaging, and data. Upon interacting with the bazaar menu to select a service plan in the menu, the user's cell-phone may access and use the cell-phone network(s) under the terms of the service plan.

The bazaar menu is optionally displayed on the screen of the user's cell phone to which the selected service plan will apply. Alternatively or additionally, the bazaar menu may be displayed on the screen of a separate device, through which the user selects the desired service plan for the user's cell phone. In certain embodiments of the invention, an agent acting as a representative of one or more users may interact with the bazaar menu to select service plans for cell phones of the one or more users. As used hereinbelow, the term “user” or “cell-phone user” may refer to the cell-phone user or the agent.

According to an aspect of an embodiment of the invention, the menu is configured to be responsive to a current location of the user's cell-phone and provides a selection of plans chosen from plans offered by service providers that are supported by “local” cell-phone networks that are within range of the current location of the cell-phone. Plans that are supported by local networks may be referred to as “local plans”. Optionally, the cell-phone determines which cell-phone networks are local cell-phone networks and which plans are local plans. In an embodiment of the invention, a known distribution of cell-phone networks in a geographical region in which the cell-phone is located determines which cell-phone networks are local cell-phone networks.

In an embodiment of the invention, a cell-phone user may request, and be provided with by the bazaar, a menu of “non-local” service plans. A non-local service plan is a service plan supported by an out of range, “non-local”, cell-phone network for a region in which the user and cell-phone are not currently located but to which the user may travel in the future. The user may select a non-local service plan from the menu so that upon traveling to the region, the user's cell-phone automatically connects to the non-local cell-phone network providing the selected non-local service plan, if the cell-phone network is within range of the user cell-phone.

In an embodiment of the invention, a cell-phone user may request, and be provided by the bazaar, a menu of “reservations” towards purchasing a service plan in the future, optionally at a price that is determined at the time the reservation is acquired.

In an embodiment of the invention the bazaar menu comprises a service plan for which the user may bid against other users towards purchasing the service plan. If the user provides a winning bid the user may use the service provided by the service plan. In an embodiment of the invention the user may, through the bazaar, request a service plan with a desired set of service parameters for which a plurality of service providers offer a price and bid against other service providers. The user may then select one or more of the bidding service providers to provide the desired service plan.

An aspect of an embodiment of the invention relates to a method of generating and providing an interactive bazaar menu that lists cell-phone service plans on a user's cell-phone and enables the user to purchase and implement use of a listed service plan on the menu by interacting with the menu.

In an embodiment of the invention, to provide a cell-phone bazaar, a bazaar provider enters into “agency agreements” with service providers to market and sell their service plans directly from menus that the bazaar may provide to cell-phone users that are registered to access the bazaar. The bazaar provider solicits and enters into agreements with the users to register the user for access to the bazaar and allow the bazaar to display bazaar service plan menus on their respective cell-phones. To implement use of the bazaar menus, the registered user may optionally download a mobile application (App) to his or her cell-phone that configures the cell-phone to access and communicate with the bazaar and select and use a cell-phone service plan displayed on the bazaar menu. Alternatively, a SIM card or a processor of the user's cell phone may be preconfigured with a functionality, which may be referred to as a “SIM toolkit”, that allows the cell-phone to access and communicate with the bazaar for displaying, selecting and using the service plan of the bazaar menu. For convenience of presentation, unless stated expressly or implied otherwise, the term “App” is used hereinafter to refer to the App and/or the SIM toolkit. Upon selection of a cell-phone service plan, the bazaar transmits data responsive to the selected plan to the cell-phone through the App to configure a microprocessor in the cell-phone that controls interfacing of the cell-phone with the cell-phone network supporting the selected service plan. In an embodiment of the invention, the bazaar provider may function to authenticate the connection of the user's cell phone to the cell-phone network supporting the selected service plan.

In an embodiment of the invention, the bazaar provider operates a SIM server having a library comprising a plurality of SIMs, hereinafter also referred to as “library SIMs”, associated with different service plans, optionally provided by a plurality of different cell-phone networks. The user registered with the bazaar may be issued with a “proxy” SIM that is configured to present an alias identity associated with a library SIM. The different service plans are advertised by the bazaar provider on the bazaar menu. Upon a user selecting a service plan, the bazaar provider enables the proxy SIM to use the alias identity of the library SIM associated with the selected service plan to access the cell-phone network under the terms of the service plan.

There is therefore provided in accordance with an embodiment of the invention a cell-phone comprising a set of executable instructions that configures the cell-phone to: receive and display a menu showing a plurality of service plans for selection by the user, each service plan being characterized with one or more terms under which the user uses the services of a cell-phone network; determine a selection that a user makes; and transmit a message via a communication network making the selection of the service plan known.

In accordance with an embodiment of the invention, the set of executable instructions configures the cell-phone to: enable the user to bid for use of the selected service plan, wherein the message comprises a bidding price.

In accordance with an embodiment of the invention, the set of executable instructions configures the cell-phone to: receive and display a menu showing a plurality of terms for determining the plurality of service plans for selection by the user; and transmit a message via the communication network making the selection of one or more of the plurality of terms known.

In accordance with an embodiment of the invention, the set of executable instructions configures the cell-phone to: receive and display a menu showing a plurality of reservations characterized by a service plan and a predetermined price for purchasing the service plan within a predetermined time period in the future; and transmit a message via the communication network making the selection of one or more of the plurality of reservations known.

In accordance with an embodiment of the invention, the set of executable instructions configures the cell-phone to present an alias associated with a SIM associated with selected service plan. Optionally, the set of executable instructions configures the cell-phone to receive an IMSI of a SIM associated with the selected service plan.

In accordance with an embodiment of the invention, the one or more terms comprises one or more of the group consisting of: availability of a service for use by the user, a service provider identification, a geographical coverage of the service, a time period for the availability of the service, and a billing rate for the service.

Optionally, the menu of service plans is responsive to a current location of the cell-phone. Alternatively, the menu of service plans is responsive to a location selected by the user that is different from the current location of the cell-phone.

Optionally, the communications network is a cell-phone network and/or the Internet.

There is further provided in accordance with an embodiment of the invention a system for providing a user of a cell-phone with a marketplace for service plans through which the user uses the services of a cell-phone network, the system comprising: a computer system configured to generate and transmit over a communication network an menu of a plurality of service plans for selection by the user, each service plan being characterized with one or more terms under which the user uses the services of a cell-phone network; and a cell-phone configured to receive the menu, display the menu to a user for selection of a desired service plan, and to transmit to the computer system a message making the selection of the desired service plan known.

In accordance with an embodiment of the invention, the cell-phone is configured to enable the user to bid for use of the selected service plan and the message makes a bidding price known.

In accordance with an embodiment of the invention, the computer system is configured to generate and transmit a menu of a plurality of terms for selection by the user; the cell-phone is configured receive and display the menu of terms to a user for selection of one or more desired terms, and to transmit to the computer system a message making the selection of terms known; and the computer system is configured to generate and transmit the menu of service plans responsive to the message making known the selection of terms.

In accordance with an embodiment of the invention, the cell-phone is configured to receive and display a menu showing a plurality of reservations characterized by a service plan and a predetermined price for purchasing the service plan within a predetermined time period in the future, and to transmit to the computer system a message making known the selected reservation; and the computer system is configured to generate and transmit the menu service plans responsive to the selected reservation.

Optionally, the computer system transmits an IMSI of a SIM associated with the selected service plan; and the cell-phone receives the IMSI.

In accordance with an embodiment of the invention, the one or more terms comprises one or more of the group consisting of: availability of a service for use by the user, a service provider identification, a geographical coverage of the service, a time period for the availability of the service, and a billing rate for the service.

In accordance with an embodiment of the invention, the menu of service plans is responsive to a current location of the cell-phone. Alternatively, the menu of service plans is responsive to a location selected by the user that is different from the current location of the cell-phone.

Optionally, the communications network is a cell-phone network and/or the Internet.

There is further provided in accordance with an embodiment of the invention a method of providing a user of a cell-phone with a service plan characterized by a plurality of terms under which the user uses the services of a cell-phone network, the method comprising:

providing to the user through a communication device an interactive menu showing a plurality of service plans for selection by the user, each service plan being characterized with one or more terms; determining a selection out of said plurality of service plans that the user makes from the interactive menu; and enabling the cell-phone user to communicate using the cell-phone in accordance with the terms of the selected service plan.

In accordance with an embodiment of the invention, the method further comprises providing to a plurality of users through the respective user's communication device an interactive menu showing a plurality of service plans with one or more terms characterizing each service plan for selection and entry of a bidding price by the respective user; determining for a given service plan a winning user from said plurality of users, responsive to bidding prices entered by a plurality of users for the given service plan; and enabling the winner user to communicate using the cell-phone in accordance with the terms of the given service plan.

In accordance with an embodiment of the invention, the method further comprises showing through the interactive menu a plurality of terms for selection by the user and determining one or more selected terms from the plurality of terms, wherein the plurality of service plans shown in the menu is determined responsive to the one or more selected terms.

In accordance with an embodiment of the invention, the method further comprises showing through the interactive menu a plurality of reservations characterized by a service plan and a predetermined price for purchasing a service plan within a predetermined time period in the future; determining a selection from the plurality of reservations; and enabling the user to purchase the service plan in accordance with the predetermined price and the predetermined time period of the selected reservation.

In accordance with an embodiment of the invention, enabling the cell-phone user to communicate using the cell-phone in accordance with the terms of the selected service plan comprises configuring the cell-phone to present an alias associated with a SIM associated with selected service plan. Optionally, enabling the user to communicate using the cell phone comprises transmitting to the cell phone an IMSI of the SIM associated with the service plan.

Optionally, the communication device is the user cell-phone. Alternatively, the communication device is a second device that communicates with the user cell-phone.

Optionally, the one or more terms comprises one or more of the group consisting of: availability of a service for use by the user, a service provider identification, a geographical coverage of the service, a time period for the availability of the service, and a billing rate for the service.

Optionally, the menu of service plans is responsive to a current location of the cell-phone. Alternatively, the menu of service plans is responsive to a location selected by the user that is different from the current location of the cell-phone.

There is further provided in accordance with an embodiment of the invention a method for generating an interactive menu that lists cell-phone service plans and enables a user to select a listed service plan for implementation in a cell-phone, the method comprising: providing an interactive interface through a first computing device for service providers to enter service plans for listing in an interactive menu; and enabling the user to register for gaining access to the interactive menu through a second computing device for selecting a service plan listed in the interactive menu for implementation in the cell phone. Optionally, the registered user downloads an App to the second computing device that configures the second computing device for providing the interactive menu.

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the description and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIG. 1 shows a flow diagram illustrating configuration and operation of a cell-phone bazaar in accordance with an embodiment of the invention.

### DETAILED DESCRIPTION

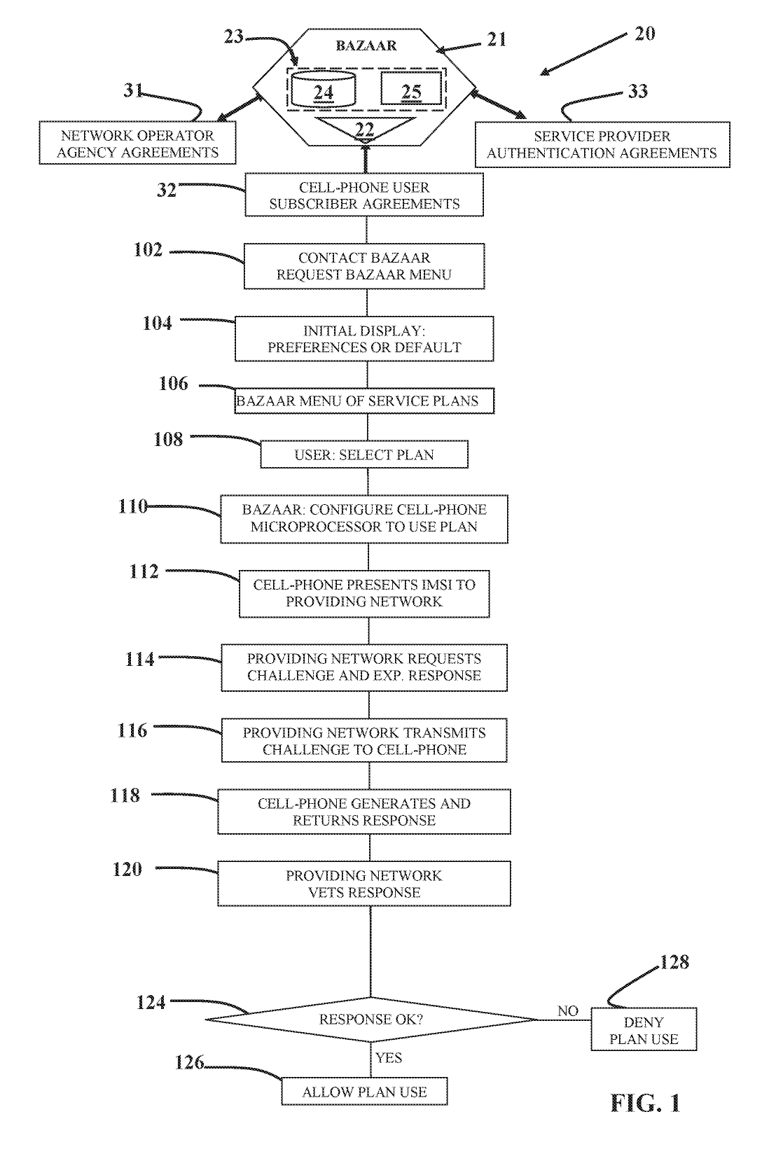

FIG. 1 shows a flow diagram 20 schematically illustrating configuration of a cell-phone bazaar 21 and operation of the cell-phone bazaar in accordance with an embodiment of the invention. Bazaar 21 comprises communication equipment 22 that connects the bazaar to a communication network (not shown) which provides connection to a cell-phone network and/or the Internet, and a computer system 23 comprising a memory 24 for storing data and at least one processor 25 for processing data stored in the memory.

In a block 31 a provider (not shown) of bazaar 21 negotiates agency agreements with cell-phone network operators (not shown) to allow cell-phone bazaar 21 to sell service plans to cell-phone users to use the operators' respective cell-phone-networks. Identities of cell-phone operators having agency agreements with bazaar 21, details of how to access the cell-phone operators and their networks and service plans they have agreed to market via the bazaar are optionally stored in an agency data base (not shown) in memory 24.

In a block 32 the bazaar provider solicits users to register for access to bazaar 21 and agree to receive offers to purchase cell-phone service plans that the bazaar may have to offer. In accordance with an embodiment of the invention, a cell-phone user that is registered with the bazaar downloads as part of the registration procedure an App that is configured to interface the user's cell-phone with the bazaar, optionally via a cell-phone network, and/or the Internet. Alternatively, the App may be implemented in the SIM toolkit that is pre-configured in a microprocessor or a SIM that is comprised in the cell-phone. The App may operate to configure the cell-phone to receive an interactive bazaar menu that lists service plans and their respective features that the bazaar has to offer for sale. The App optionally configures the cell-phone to enable the cell-phone user to interact with the bazaar menu to select and use a desired service plan from the listed plans. Identities of registered users, their cell-phones and SIMs they comprise are optionally stored in a registered user data base (not shown) in memory 24.

In a block 33 the bazaar provider optionally negotiates agreements, hereinafter “authentication agreements”, with service providers that have issued SIM cards to populations of cell-phone users that may register to access the bazaar. The authentication agreements arrange for the service providers to authenticate SIM cards that they have issued for users registered with the bazaar when the users' cell phones use the IMSIs of their SIM cards to identify themselves to cell-phone networks by virtue of purchasing a service plan from the bazaar. Identities of service providers and the SIMs they have issued to users registered with bazaar 21 are optionally stored in a service provider data base (not shown) in memory 24.

A service provider that is also a network operator may have an agency agreement with bazaar 21 to sell service plans provided by its cell-phone network. Such a service provider that is also a cell-phone network operator is generally expected to have an explicit or implicit authentication agreement with bazaar 21 to authenticate SIM cards that the service provider issued and which are associated with service plans sold by bazaar 21 under terms of its agency agreement with the bazaar. Such service providers may also have an agreement to authenticate SIM cards that it has issued for service plans provided by other cell-phone network operators.

Bazaar 21 may issue its own SIM cards and authenticate the SIM cards it issues that are associated with service plans that the bazaar sells under agency agreements it has negotiated. Optionally, the bazaar issues a proxy SIM to a cell-phone user that is registered with the bazaar. The proxy SIM may be configured to borrow and assume an alias SIM identity belonging to another SIM and use the IMSI and KI of the other SIM. In an embodiment of the invention, computer system 23 of bazaar 21 has a SIM library (not shown) comprising a plurality of library SIMs, whose identity the proxy SIM may borrow and assume as an alias identity. Each library SIM in the SIM library may be associated with a service plan and/or a service provider. When the cell-phone user registered with the bazaar chooses a service plan from a bazaar menu that is associated with a library SIM in the SIM library, the App configures the proxy SIM to use the IMSI and KI of the library SIM to access and use the cell-phone network in accordance with the selected service plan. Methods by which a proxy SIM may use an alias SIM identity are described in US 2013/0095797 the disclosure of which is incorporated herein by reference.

Blocks 102-126 illustrate operation of bazaar 21 when a user registered with the bazaar operates a user cell-phone to purchase a service plan from the bazaar in accordance with an embodiment of the invention.

In block 102 a cell-phone user registered with bazaar 21 operates his or her cell-phone to access the bazaar, through the App and request a bazaar menu that offers service plans for purchase. Optionally, the user accesses bazaar 21 via a cell-phone network to which the cell-phone is connected using an IMSI and KI of a SIM that the cell-phone comprises. In an embodiment of the invention, the user may access bazaar 21 via a connection, such as a WiFi or Bluetooth connection, to the Internet by activating the App.

In an embodiment of the invention, upon connecting to bazaar 21, in a block 104 the App presents an initial interactive display on the user cell-phone. The initial interactive display is configured to enable the user to request a default menu of cell-phone plans or a menu tailored to specific preferences of the user. If the user opts for the default menu, bazaar 21 may optionally activate the App to query the user cell-phone for a list of local cell-phone networks that the cell-phone has detected to be within range of the cell-phone and transmit a list of local cell-phone networks to bazaar 21. Processor 25 in bazaar 21 may then canvass memory 24 to determine which of the local cell-phone networks received from the App have agency agreements with the bazaar. In a block 106, processor 25 optionally generates a list of service plans that the local cell-phone networks provide. The service plan list generated by bazaar 21 is transmitted by communication equipment 22 to the user cell-phone for generating a service plan menu in the interactive display.

If on the other hand in block 104 the user opts for a preference tailored menu, the App generates a display on the user cell-phone that enables the user to indicate his or her preferences for features to be included in service plans offered for purchase in a bazaar menu. The user may for example use the display to indicate preferences for at least one or any combination of more than one of a desired cost per minute of voice communication, an amount of data the user requires per month, a geographical region where the service plan is to be used, and a start date and termination date for the plan. In block 106, processor 25 in bazaar 21 may then generate a list of service plans which substantially meet the preferences indicated by the user that are provided by cell-phone networks having agency agreements with the bazaar. The list is transmitted by communication equipment 22 to the user cell-phone. The App uses the service plan list to generate the service plan menu in the interactive display on the user cell-phone.

In a block 108 the user interacts with the menu generated in block 106, for example, by selecting a suitable icon or radio button displayed in the menu with each listed service plan to select a service plan from the menu for purchase. In a block 110 upon selection of a given service plan, the App transmits the identity of the selected service plan to bazaar 21. In response, bazaar 21 transmits instructions and data to the App that causes the App optionally in a block 110 to configure the user cell-phone microprocessor for access to the cell-phone network, referred to hereinafter as a “providing network”, that supports the service plan selected in block 108 and use services provided by the plan.

In an embodiment of the invention, a cell-phone user may request, and the bazaar may provide, a menu of “reservations” towards purchasing a service plan in the future, for example, by a defined date or within a defined window of time. In certain embodiments of the invention, the reservation may provide the user with an option to purchase a desired service plan at a price that is pre-determined at the time the reservation is acquired. The service plan may optionally be a local or a non-local plan. The user may optionally pay a fee to acquire a reservation and/or pay a fee to cancel a reservation. In certain embodiments of the invention, the bazaar may provide for the user to sell the reservation to another user.

In an embodiment of the invention, in a block 112 if the providing network is a local cell-phone network, the user cell-phone microprocessor configured by the App disconnects the user cell-phone from the local cell-phone network to which it is currently connected and controls the user cell-phone to present the IMSI of its SIM to the providing network. If on the other hand, the providing network is a non-local cell-phone network, the phone attempts to connect to the non-local cell-phone network when the cell-phone is within range of the non-local cell-phone network.

In a block 114 the providing cell-phone network requests and receives a challenge and an expected response from an authenticator (not shown). The authenticator may be an operator of the providing network, the service provider, bazaar 21, or any third party entity configured to communicate with the providing cell-phone network and provide an authentication functionality. In a block 116 the providing network transmits the challenge to the user cell phone. In a block 118 the user cell-phone receives the challenge and the user cell-phone's SIM uses its KI to process and generate a response to the challenge, which the user cell-phone transmits back to the providing network. In a block 120 upon receiving the response, the providing network compares the response received from the user cell-phone to the expected response received from the authenticator for vetting. In a decision block 124, if the response generated by the user cell-phone matches the expected response, in a block 126 the providing network allows the cell-phone to use the providing network and the services provided by the selected service plan. On the other hand, if the response is not what is expected, in a block 128 the providing network denies access and use of the service plan.

In an embodiment of the invention, the display of the user cell-phone, for example the initial interactive display generated and displayed in block 104, may optionally offer to the user an option to choose a bidding menu. In the bidding menu (not shown) the user is offered at least one service plan for which the user may submit a bid to purchase the service plan. If the user bid is successful the user acquires the service plan at the price he or she has bid for it. The bidding menu may optionally be displayed in addition to providing the cell-phone user with a choice to indicate user preferences for preference tailored plans or a default menu.

It is noted above that in an embodiment of the invention, computer system 23 of bazaar 21 optionally comprises a SIM library and provides a cell-phone user that registered with the bazaar a proxy SIM for the user cell-phone which may assume and use an alias SIM identity. Optionally in addition to being able to assume an alias SIM identity the proxy SIM comprises its own native IMSI and associated native KI which it may use to connect the user cell-phone to a cell-phone network and via the connected network to bazaar 21. Optionally, the proxy SIM may communicate via a wired or wireless connection with a “base” SIM, separate from the proxy SIM, that is comprised in the user cell-phone. The proxy SIM may communicate with the base SIM to connect the user cell-phone to a cell-phone network and via the connected cell-phone network to bazaar 21.

After connecting to bazaar 21, requesting a menu from the bazaar and selecting a desired service plan from the menu, bazaar 21 transmits an IMSI of a library SIM that is associated with the selected service plan to the user cell-phone for use by the proxy SIM as an alias. The proxy SIM presents the received alias IMSI to the cell-phone network that provides the selected service plan to connect to and use the providing cell-phone network in accordance with the terms of the selected plan. Upon receiving a challenge from the providing network in response to the presented alias IMSI, the proxy SIM transmits the challenge to bazaar 21 via the connection made using the base SIM or its own native IMSI and KI to bazaar 21. Bazaar 21 uses the library SIM associated with the alias IMSI to generate a response to the challenge and transmits the response back to the proxy SIM via the connection established by the base SIM or the native IMSI and KI of the proxy SIM. Upon receiving the response to the challenge, the proxy SIM submits the response to the providing network, which then allows the proxy SIM to assume the alias SIM identity and connect the user phone to the providing network

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A cell-phone comprising a set of executable instructions that configures the cell-phone to:
receive and display a menu showing a plurality of service plans for selection by the user, each service plan being characterized with one or more terms under which the user uses the services of a cell-phone network, wherein the plurality of service plans comprises service plans offered by different cell-phone network service providers;
determine a selection that a user makes; and
transmit a message via a communication network making the selection of the service plan known.

2. The cell-phone according to claim 1, wherein the set of executable instructions configures the cell-phone to:
enable the user to bid for use of the selected service plan, wherein the message comprises a bidding price.

3. The cell-phone according to claim 1, wherein the set of executable instructions configures the cell-phone to:
receive and display a menu showing a plurality of terms for determining the plurality of service plans for selection by the user;
transmit a message via the communication network making the selection of one or more of the plurality of terms known.

4. The cell-phone according to claim 1, wherein the set of executable instructions configures the cell-phone to:
receive and display a menu showing a plurality of reservations characterized by a service plan, a purchase price for the reservation, and a predetermined price for purchasing the service plan within a predetermined time period in the future after purchasing the reservation;
transmit a message via the communication network making the selection of one or more of the plurality of reservations known.

5. The cell-phone according to claim 1, wherein each of the displayed service plans is associated with a respective SIM from a plurality of SIMs, and the set of executable instructions configures the cell-phone to present an alias associated with a SIM associated with the selected service plan.

6. The cell-phone according to claim 5, wherein the set of executable instructions configures the cell-phone to receive an IMSI of the SIM associated with the selected service plan.

7. The cell-phone according to claim 1, wherein said one or more terms comprises one or more of the group consisting of: availability of a service for use by the user, a service provider identification, a geographical coverage of the service, a time period for the availability of the service, and a billing rate for the service.

8. The cell-phone according to claim 1, wherein the menu of service plans is responsive to a current location of the cell-phone.

9. The cell-phone according to claim 1, wherein the menu of service plans is responsive to a location selected by the user that is different from the current location of the cell-phone.

10-19. (canceled)

20. A method of providing a user of a cell-phone with a service plan characterized by a plurality of terms under which the user uses the services of a cell-phone network, the method comprising:
providing to the user through a communication device an interactive menu showing a plurality of service plans for selection by the user, each service plan being characterized with one or more terms, wherein the plurality of service plans comprises service plans offered by different cell-phone network service providers;
determining a selection out of said plurality of service plans that the user makes from the interactive menu; and
enabling the cell-phone user to communicate using the cell-phone in accordance with the terms of the selected service plan.

21. The method according to claim 20 comprising:
providing to a plurality of users through the respective user's communication device an interactive menu showing a plurality of service plans with one or more terms characterizing each service plan for selection and entry of a bidding price by the respective user;
determining for a given service plan a winning user from said plurality of users, responsive to bidding prices entered by a plurality of users for the given service plan; and
enabling the winner user to communicate using the cell-phone in accordance with the terms of the given service plan.

22. The method according to claim 20 comprising:
showing through the interactive menu a plurality of terms for selection by the user and determining one or more selected terms from the plurality of terms;
wherein the plurality of service plans shown in the menu is determined responsive to the one or more selected terms.

23. The method according to claim 20 comprising:
showing through the interactive menu a plurality of reservations characterized by a service plan, a purchase price for the reservation, and a predetermined price for purchasing a service plan within a predetermined time period in the future after purchasing the reservation;
determining a selection from the plurality of reservations; and
enabling the user to purchase the service plan in accordance with the predetermined price and the predetermined time period of the selected reservation.

24. The method according to claim 20, wherein each of the shown service plans is associated with a respective SIM from a plurality of SIMs, and enabling the cell-phone user to communicate using the cell-phone in accordance with the terms of the selected service plan comprises configuring the cell-phone to present an alias associated with a SIM associated with the selected service plan.

25. The method according to claim 24, wherein enabling the user to communicate using the cell phone comprises transmitting to the cell phone an IMSI of the SIM associated with the service plan.

26. The method according to claim 20, wherein the communication device is the user cell-phone.

27. The method according to claim 20, wherein the communication device is a second device that communicates with the user cell-phone.

28. The method according to claim 20, wherein said one or more terms comprises one or more of the group consisting of: availability of a service for use by the user, a service provider identification, a geographical coverage of the service, a time period for the availability of the service, and a billing rate for the service.

29. The method according to claim 20, wherein the menu of service plans is responsive to a current location of the cell-phone.

30. The method according to claim 20, wherein the menu of service plans is responsive to a location selected by the user that is different from the current location of the cell-phone.

31-32. (canceled)
